(19) United States
(12) Patent Application Publication
(10) Pub. No.: US 2007/0258111 A1
(43) Pub. Date: Nov. 8, 2007

(54) SIP ADAPTER AND SIP COMMUNICATION SYSTEM

(75) Inventor: Noritaka Ooizumi, Shizuoka (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Access Technica, Ltd., Shizuoka (JP)

(21) Appl. No.: 11/691,680

(22) Filed: Mar. 27, 2007

(30) Foreign Application Priority Data
Mar. 29, 2006 (JP) 2006-090030

(51) Int. Cl. H04N 1/00

(52) U.S. Cl. 358/402

(57) ABSTRACT

Facsimile devices having no SIP function or operating based on different protocols are allowed to easily perform good facsimile communication over a SIP network, only with a telephone number input. A SIP adapter is connected to a facsimile device and enables the facsimile device to perform direct facsimile communication with the other facsimile device. When inputting a telephone number from the facsimile device, the SIP adapter sends the telephone number to the SIP server and acquires the IP address of another SIP adapter connected to the other facsimile device. After establishing a session between the SIP adapters, the SIP adapter acquires the IP address of the other facsimile device and transmits facsimile image data to the other facsimile device.

### BACKGROUND OF THE INVENTION

1. Field of the Invention

The present invention relates to a SIP communication system and, more particularly, to a SIP adapter that enables telephony or facsimile communication over an IP (Internet Protocol) network by establishing a session in concert with a SIP server, based on the Session Initiation Protocol (SIP) defined in RFC (Request for Comments) 3261.

2. Description of the Related Art

Taking facsimile transmission/reception over a network as an example, conventional facsimile transmission/reception is performed by the following sequence: a transmitting device inputs the mail address of a receiving device and transmits a facsimile to a mail server by using Internet FAX; and the receiving device receives the facsimile from the mail server by using the Post Office Protocol version 3 (POP3) or the Internet Message Access Protocol (IMAP).

Apart from this method, another method is also employed in which a transmitting device inputs the IP address or host name of a receiving device and, with a receiving device provided with a SMTP server function, facsimile transmission and reception are carried out by using direct SMTP (a communication method of enabling data transmission and reception by using the Simple Mail Transfer Protocol (SMTP)), bypassing a mail server.

However, the above methods use other identification codes (e.g., mail address, IP address, host name, and the like) besides telephone numbers which are generally widely used. Therefore, these identification codes need to be newly stored or managed, which is bothersome and inconvenient for users.

To solve this downside, a facsimile device has been proposed that can perform image transmission to an arbitrary destination only with an input of a telephone number, by accessing a SIP server or the like present on a network and having the SIP server translate the telephone number into an IP address (for example, see Japanese Patent Application Unexamined Publication No. 2005-223693).

According to the above facsimile device, a calling party can carry out facsimile communication with an arbitrary party only by entering the party's telephone number. Therefore, users do not need to store or manage identification codes other than telephone numbers, which accomplishes a mechanism that can solve the above-described problem.

However, in some cases, the above facsimile device might fail or have some trouble in a communication when there are differences in the contents of the SIP protocol processed among the SIP server and facsimile devices involved.

For example, the way of expressing a URI, content of a SIP header and the like vary depending on the makers and providers that manufacture or provide SIP servers and SIP-compliant terminals, sometimes leading to the impossibility of communication.

In addition, SIP is primarily a protocol that prescribes basic call control only, and the RFC in question does not give particular description of the data exchange performed after a connection (session) is established. For example, in additional functions such as “hold” and “transfer” in the telephone services, a malfunction or trouble due to the differences among the makers and the like also has turned into problems.

To solve such problems, the complete unification of the specifications of the protocol is desirable. However, in that case, flexibility is limited, and strict prescription is against the spirit of SIP, which is characterized by flexibility and expandability. Further, it can be hardly hoped that the makers, or providers, accomplish the unification of specifications for themselves.

On the other hand, the above-described problems can also be evaded by developing and manufacturing a facsimile device that can accommodate all the differences on the protocol. This, however, causes enormous costs and therefore is not realistic.

### SUMMARY OF THE INVENTION

Accordingly, the present invention is proposed to solve the problems that have confronted the conventional technologies as described above.

An object of the present invention is to provide a SIP communication method and SIP adapter that enables a communication device having no SIP function and/or operating based on a different protocol to carry out good communication over an IP network, by performing SIP control in concert with a SIP server. In addition, the SIP communication method and SIP adapter allow a facsimile device to carry out direct communication with another facsimile device on the IP network, only with a telephone number being input to the facsimile device on the transmitting side.

According to the present invention, an adapter for providing a network-capable device with SIP (Session Initiation Protocol) function to allow SIP communication of the network-capable device through an IP (Internet Protocol) network on which a SIP server is present, includes: a receiving section for receiving a destination telephone number of a destination network-capable device from the network-capable device; a session establishment section for establishing a session between the adapter and a destination SIP terminal by using the SIP server, wherein the destination SIP terminal is provided to the destination network-capable device, wherein the session establishment section sends the destination telephone number to the SIP server, which uses a redirect server function to obtain the first IP address of the destination SIP terminal; an IP address acquisition section for acquiring a second IP address of the destination network-capable device from the destination SIP terminal through the session; and an IP address transfer section for transferring the second IP address to the network-capable device, allowing direct communication between the network-capable device and the destination network-capable device over the IP network.

According to another aspect of the present invention, an adapter for providing a network-capable device with SIP (Session Initiation Protocol) function to allow SIP communication of the network-capable device through an IP (Internet Protocol) network on which a SIP server is present, includes: a first controller controlling communication with the network-capable device such that a destination telephone number is received from the network-capable device and a destination IP address corresponding to the destination telephone number is sent back to the network-capable device; and a second controller controlling SIP communication such that the destination IP address is acquired from a destination network-capable device by using the SIP server, allowing direct communication with the destination network-capable device through the IP network.

According to a first embodiment of the present invention, the session establishment section includes a first address acquisition section for sending the destination telephone number to the SIP server and receiving the first IP address from the SIP server, wherein the session establishment section sends a connection request to the destination SIP terminal to establish the session.

According to a second embodiment of the present invention, the SIP server uses a proxy server function to send a connection request to the destination SIP terminal based on the first IP address to cause the adapter and the destination SIP terminal to establish the session.

According to a third embodiment of the present invention, the destination SIP terminal is incorporated as a SIP function in the destination network-capable device.

In the case where the adapter receives a connection request from either a source SIP terminal or the SIP server, the session establishment section also establishes a session with a source SIP terminal, wherein the IP address acquisition section also acquires the first IP address of the network-capable device and sends the first IP address to the source SIP terminal through the session with the source SIP terminal.

According to the above-described adapter, control can be designed such that a session is established between the adapter and the SIP terminal in concert with the SIP server based on the redirect server function or proxy server function of the SIP server, and that the following communication is directly performed between the network-capable devices.

Therefore, the communication can be performed without being routed through a server or the like, enabling high-quality IP telephony or facsimile data to be transmitted and received at high speed.

In addition, connecting the adapter to a network-capable facsimile device having no special functions enables this facsimile device to work as if it has a SIP function.

Therefore, the adapter can be easily connected to a conventional facsimile device and used, reducing the costs involved in the purchase of a facsimile device, modification thereof, or the like.

Even in the case where different protocols are used among the server and communicating devices, good facsimile communication can be achieved only by changing or improving SIP adapters, without changing facsimile devices.

Moreover, the use of the redirect server function or proxy server function of SIP makes it possible to always track the latest location information and support the mobility of a user and terminal. Therefore, a SIP adapter with excellent usability can be provided.

The first IP address of the destination SIP terminal and the destination telephone number of the destination network-capable device may be previously registered in a database by a registrar server function of the SIP server. Further, an IP address of the adapter and a telephone number of the network-capable device may be previously registered in the database by the registrar server function of the SIP server.

Accordingly, the IP address of an adapter and the telephone number of a network-capable device connected to the adapter are registered in the database, associated with each other. Accordingly, even on an IP network, a location (address) can be specified by using a telephone number.

Therefore, communication with a desired network-capable device can be achieved only by designating a telephone number. In the case of facsimile transmission, the need to use an identification code (e.g., mail address, IP address, host name, etc.) other than a telephone number can be eliminated. Accordingly, facsimile services excellent in operability and convenience can be realized.

A SIP communication method according to the present invention provides SIP (Session Initiation Protocol) communication between a first network-capable device provided with a first SIP terminal and a second network-capable device provided with a second SIP terminal through an IP (Internet Protocol) network on which a SIP server is present. The first SIP terminal receives a destination telephone number of a destination network-capable device from the first network-capable device; and sends the destination telephone number to the SIP server, wherein the SIP server uses a redirect server function to obtain a first IP address of the second SIP terminal. The first and second SIP terminals establish a session between the first SIP terminal and the second SIP terminal by using the SIP server; and the first SIP terminal acquires a second IP address of the second network-capable device from the second SIP terminal through the session to transfer the second IP address to the first network-capable device. The first and second network-capable devices perform direct communication between the first network-capable device and the second network-capable device over the IP network.

From the view point of a SIP terminal at a receiving side, the second SIP terminal receives a connection request from either the first SIP terminal or the SIP server; establishes the session with the first SIP terminal; acquires the second IP address of the second network-capable device from the second SIP terminal; and sends the second IP address to the first SIP terminal through the session.

As described above, the present invention can be accomplished not only as an apparatus invention as described earlier but also as a method invention.

In addition, when the destination network-capable device has a SIP function, the present invention can be implemented without the need for the destination SIP adapter, resulting in enhanced versatility and expandability.

Further, the present invention can also be accomplished as a program. Accordingly, the present invention can be implemented not only by a SIP adapter but also by installing the program in a network-capable device itself, resulting in enhanced versatility and expandability.

As described above, according to the present invention, a session can be established by performing call control in accordance with the SIP protocol. Therefore, even if a network-capable device such as IP telephone or facsimile device has no SIP function, or even if there is a difference on the SIP protocol among the devices involved in communication, SIP-compliant services can be easily realized and provided at low cost by connecting, or changing to, any one of the SIP adapters of the present invention.

In addition, direct communication is performed with an input of a telephone number. Therefore, operability and usability can be enhanced, and high-speed, high-quality facsimile services can be provided.

### BRIEF DESCRIPTION OF THE DRAWINGS

FIG. 1 is a diagram of a network structure embodying a SIP facsimile communication method according to a first embodiment of the present invention.

FIG. 2 is a block diagram showing the basic configurations of a SIP adapter and a facsimile device used to embody the SIP facsimile communication method according to the first embodiment of the present invention.

FIG. 3 is a sequence diagram showing operation processes in the coordination of the SIP adapters, facsimile devices and a SIP server according to the first embodiment of the present invention in the case where call control by a redirect server is used.

FIG. 4 is a sequence diagram showing operation processes in the coordination of the SIP adapters, facsimile devices and SIP server according to the first embodiment of the present invention in the case where call control by a proxy server is used.

FIG. 5 is a sequence diagram showing operation processes in the coordination of the SIP adapters, facsimile devices and SIP server according to the first embodiment of the present invention in the case where the source facsimile device is provided with a SIP function.

FIG. 6 is a sequence diagram showing operation processes in the case where encryption and decryption are performed by using SSL/TLS in a SIP facsimile communication method according to a second embodiment of the present invention.

### DETAILED DESCRIPTION OF THE PREFERRED EMBODIMENTS

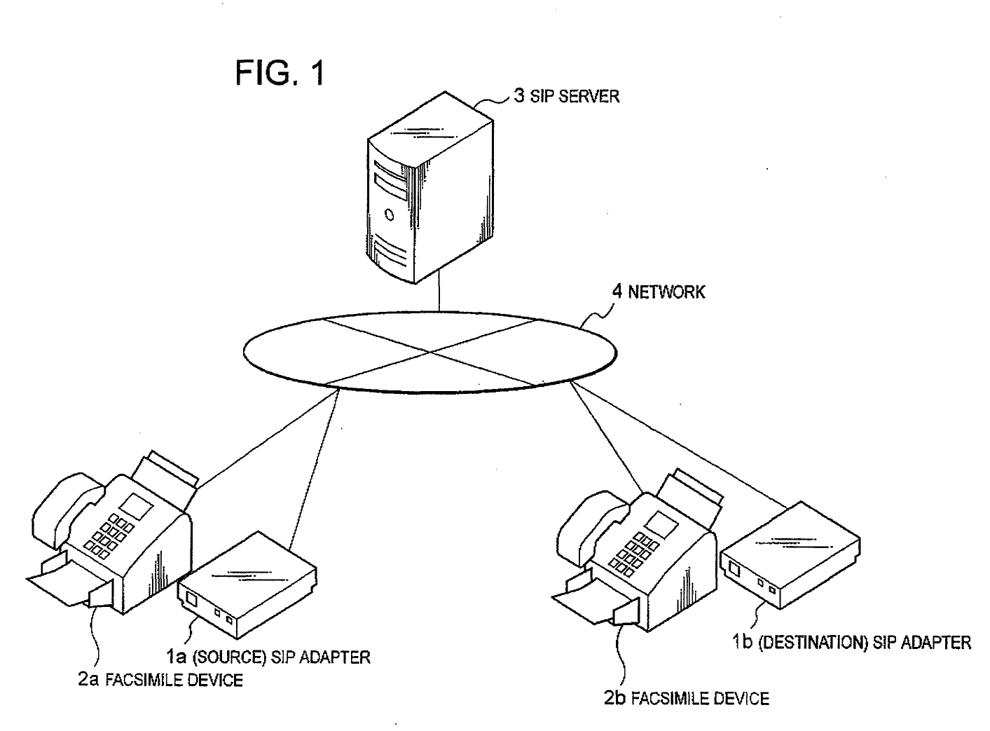

Hereinafter, preferred embodiments of the present invention will be described with reference to FIGS. 1 to 6.

Here, a SIP facsimile communication method using a SIP adapter according to any one of the embodiments described below may be implemented by a computer executing processes, means and functions in accordance with instructions of a program (software). The program instructs components or hardware resources of the computer to perform predetermined processing and/or functions as described below. That is, each process and means in the SIP facsimile communication method using the SIP adapter according to any one of the embodiments is implemented by specific means that are accomplished by the program and the computer operating in concert with each other.

Incidentally, part or the whole of the program is provided by means of a magnetic disk, an optical disk, a semiconductor memory, or any other computer-readable recording medium, and the program read out of the recording medium is installed in the computer and then executed. Additionally, the program can also be executed after loaded directly into the computer through a communication link, not by means of a recording medium.

### 1. First Embodiment

FIG. 1 is a schematic diagram of a network embodying a SIP facsimile communication method according to a first embodiment of the present invention.

As shown in FIG. 1, a SIP adapter 1, a facsimile device 2 and a SIP server 3 are connected to each other through a network 4. The SIP facsimile communication method according to the first embodiment is implemented in such a manner that the SIP adapter 1, the facsimile device 2 and the SIP server 3 operate in concert with each other, in accordance with predetermined control means.

Here, the SIP adapter 1 performs call control according to SIP, in concert with the SIP server 3. Connected to the facsimile device 2, the SIP adapter 1 substantially adds a SIP function to the facsimile device 2. In the present embodiment, description will be given on the assumption that the SIP adapter on the facsimile-transmitting side is referred to as a source SIP adapter 1a and the SIP adapter on the facsimile-receiving side is referred to as a destination SIP adapter 1b.

The facsimile device 2 is an IP network-capable facsimile device. In the present embodiment, description will be given on the assumption that the facsimile device on the facsimile-transmitting side is referred to as a source facsimile device 2a and the facsimile device on the facsimile-receiving side is referred to as a destination facsimile device 2b.

The SIP server 3 performs call control on SIP terminals connected to the network 4 and operates in accordance with protocols defined in RFC 3261.

The SIP server 3 has three different basic functions: proxy server, redirect server, and registrar server functions. The SIP server 3 is designed to fulfill a primary SIP role by these functions operating in combination.

Outlines of the specific roles of the basic functions will be described below individually.

The proxy server receives a request or the like from a SIP terminal and forwards it to another SIP terminal or the like designated.

The redirect server responds to a request from a SIP terminal with an address (IP address in the present embodiment) of the destination of communication.

The registrar server accepts a REGISTER request regarding the current location of a SIP terminal and registers the current location of the SIP terminal with a predetermined location server.

Additionally, the network 4 means an IP network and, particularly in the present embodiment, it means a SIP network on which the SIP server 3 is present.

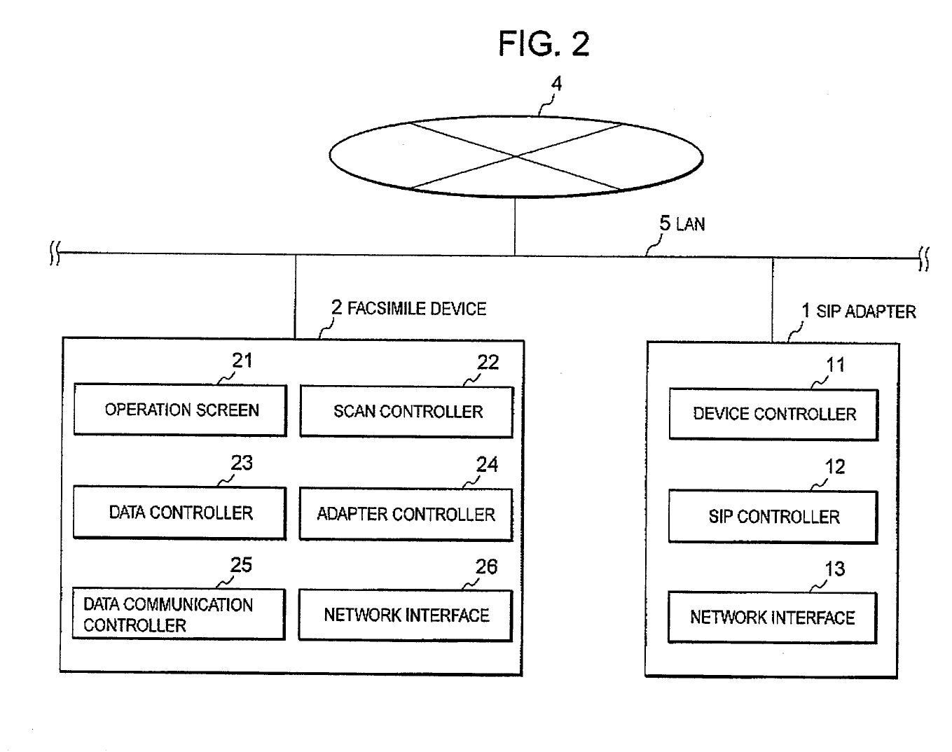

Next, the primary constituent devices of the present embodiment will be described with reference to FIG. 2. FIG. 2 is a block diagram showing the basic configurations of the SIP adapter and facsimile device used to embody the SIP facsimile communication method according to the first embodiment of the present invention.

### 1.1) SIP Adapter

As shown in FIG. 2, the SIP adapter 1 includes a device controller 11, a SIP controller 12, and a network interface 13.

The device controller 11 controls communication between the facsimile device 2 and the SIP adapter 1. In the case of the source SIP adapter 1a, for example, the device controller 11 performs reception of a telephone number input at the facsimile device 2a, and transmission of an acquired IP address to the facsimile device 2a, etc. Accordingly, the device controller 11 implements a receiving section and an IP address transfer section.

The SIP controller 12 controls the communications with the SIP server 3, destination facsimile device 2b and destination SIP adapter 1b. For example, the SIP controller 12 of the source SIP adapter 1a IP addresses from the destination SIP adapter 1b and destination facsimile device 2b individually and establishes a session between the SIP adapters. Accordingly, the SIP controller 12 implements a session establishment section and an IP address acquisition section.

The network interface 13 connects the SIP adapter 1 to the facsimile device 2 through a LAN 5.

### 1.2) Facsimile Device

As shown in FIG. 2, the facsimile device 2 includes an operation screen 21, a scan controller 22, a data controller 23, an adapter controller 24, a data communication controller 25, and a network interface 26.

The operation screen 21 is a device composed of a touch panel and the like, and a user can enter various kinds of information through this operation screen 21. In the present embodiment in particular, a telephone number to specify the destination facsimile device 2b is input by a user's operation on the operation screen 21.

The scan controller 22 scans an original including characters and/or pictures to capture the image of the original to be transmitted. The scanned image data is sent to the data controller 23.

The data controller 23 controls temporal storing and processing of the scanned original data or other yet-to-be-outputted image data which is received from another facsimile device 2a.

The adapter controller 24 controls the communication with the SIP adapter 1.

The data communication controller 25 controls the data communication with a facsimile device 2 that is the other end of communication. For example, the data communication controller 25 of the source facsimile device 2a carries out capability exchange with the destination facsimile device 2b prior to actual data transmission and acquires the reception capabilities (e.g., paper size, image quality, capability of color reception, and the like) of the destination facsimile device 2b, as well as executes the data communication between the facsimile devices in accordance with a predetermined communication protocol (direct SMTP or the like).

The network interface 26 connects the facsimile device 2 to each of the network 4 and the SIP adapter 1 through the LAN 5.

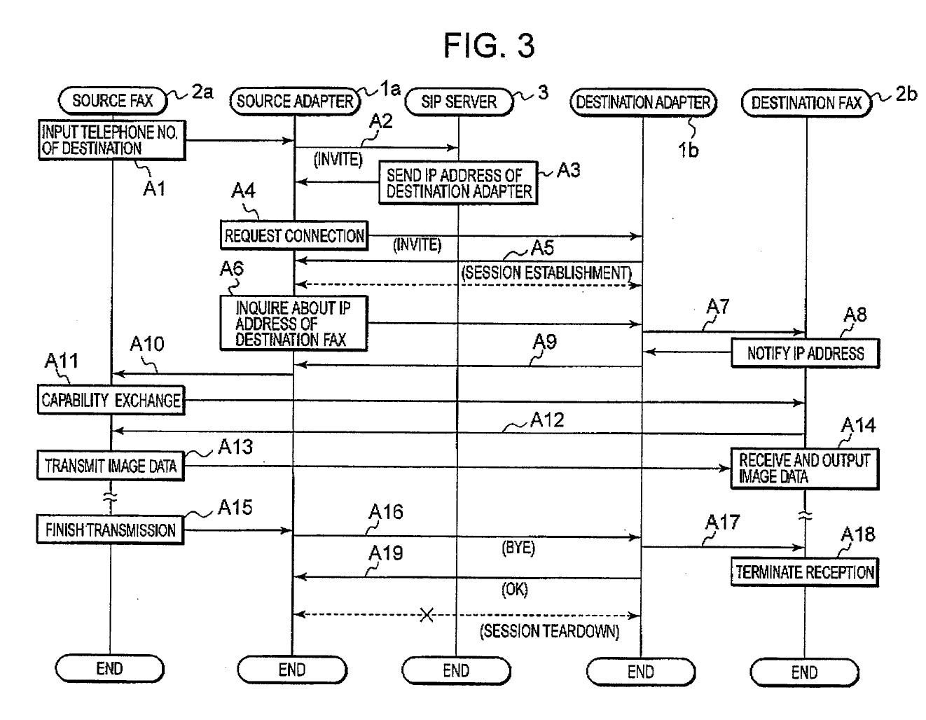

Next, description will be given of the coordinative operations of the thus configured SIP adapters, facsimile devices and SIP server, which embody the SIP facsimile communication method according to the first embodiment, with reference to FIGS. 3 to 5.

### 1.3) Operation

### EXAMPLE I

FIG. 3 is a sequence diagram showing operation processes in the coordination of the SIP adapters, facsimile devices and SIP server according to the first embodiment of the present invention, in the case where the call control by the redirect server is used.

First, a user sets an original to transmit on the source facsimile device 2a and makes a call by entering the telephone number of the destination facsimile device 2b (step A1). Upon this operation, the original is scanned, and its image data is temporally stored. At the same time, the telephone number is sent to the source SIP adapter 1a.

Upon the receipt of the telephone number, the source SIP adapter 1a sends an INVITE request containing this telephone number to the SIP server 3 (step A2). Here, the INVITE request is a message inviting an arbitrary party to participate a session.

Upon receipt of the INVITE request, the SIP server 3 refers to the telephone number contained in the request, extracts a corresponding IP address from a predetermined database, and sends the IP address back to the source SIP adapter 1a A3). Here, the extraction of the IP address is executed by a location server linked to the SIP server 3. Accordingly, it is necessary for each SIP adapter 1 to previously send a registration request to the registrar server so that the IP address is mapped into the telephone number of the facsimile device 2 to register them with the location server.

Upon receipt of the IP address of the destination SIP adapter 1b, the source SIP adapter 1a sends an INVITE request to that IP address, that is, to the destination SIP adapter 1b and requests a participation in a session (connection) (step A4).

When the destination SIP adapter 1b responds to the request in the step A4 with an OK response and the source SIP adapter 1a receives this response (step A5), then a session between the SIP adapters 1a and 1b is established.

Next, the source SIP adapter 1a inquires of the destination SIP adapter 1b about the IP address of the destination facsimile device 2b (step A6).

Upon the inquiry in the step A6, the destination SIP adapter 1b refers to the destination facsimile device 2b for its IP address (step A7).

The destination facsimile device 2b sends its own IP address to the destination SIP adapter 1b (step A8). Upon receipt of this, the destination SIP adapter 1b sends the IP address in question to the source SIP adapter 1a (step A9). Further, upon receipt of this, the source SIP adapter 1a sends this IP address to the source facsimile device 2a (step A10).

Prior to facsimile transmission, the source facsimile device 2a carries out capability exchange (steps A11 and A12).

Specifically, the source facsimile device 2a sends an inquiry to the IP address received in the step A10, that is, the destination facsimile device 2b about the receivable paper size, image quality, capability of color reception, and the like and checks these items.

Then, the source facsimile device 2a transmits the image data that has been scanned at the source facsimile device 2a and stored in the data controller 23, directly to the destination facsimile device 2b by using direct SMTP (step A13). The destination facsimile device 2b receives and outputs the image data (step A14).

When the transmission of the image data is finished and the facsimile communication is completed, then the source facsimile device 2a sends a predetermined notification to the source SIP adapter 1a (step A15).

Upon receipt of this notification, the source SIP adapter 1a sends a BYE message to the destination SIP adapter 1b (step A16). Here, the BYE message is a message indicating a teardown of the session.

Upon receipt of the BYE message, the destination SIP adapter 1b sends a predetermined notification to the destination facsimile device 2b (step A17).

Upon receipt of the notification in the step A17, the destination facsimile device 2b here terminates the facsimile reception and brings itself back to an original standby state (step A18).

Thereafter, the destination SIP adapter 1b responds to the BYE message with an OK response, whereby the teardown of the session is completed (step A19).

### 1.4) Operation

### EXAMPLE II

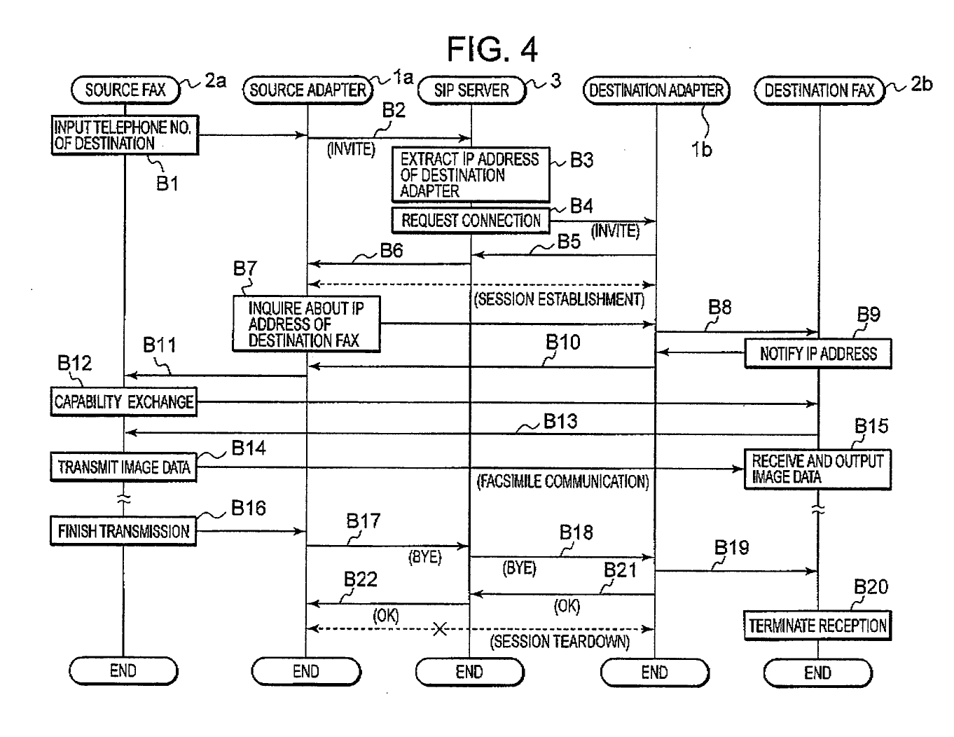

Next, description will be given of an operation procedure in the case where the proxy server is used, in the coordinative operations of the SIP adapters, facsimile devices and SIP server according to the present embodiment, with reference to FIG. 4.

FIG. 4 is a sequence diagram showing operation processes in the coordinative operations of the SIP adapters, facsimile devices and SIP server according to the first embodiment of the present invention, in the case where the call control by the proxy server is used.

First, as in the case where the redirect server is used, the telephone number of the destination facsimile device 2b is input to the source facsimile device 2a and sent to the source SIP adapter 1a (step B1).

Upon receipt of the telephone number, the source SIP adapter 1a sends an INVITE request containing this telephone number to the SIP server 3 (step 52).

Next, upon receipt of the INVITE request, the SIP server 3 refers to the telephone number contained in the request and extracts a corresponding IP address (step B3). At the same time, the SIP server 3 forwards the INVITE request to that IP address, that is, the destination SIP adapter 1b (step B4).

The destination SIP adapter 1b responds to the INVITE request with an OK response (step B5). Upon receipt of this, the SIP server 3 sends the OK response back to the source SIP adapter 1a (step B6).

In this manner, a session between the SIP adapters is established.

After the session is established, a procedure of the processes up to the facsimile communication (steps B7 to B15) is similar to the above-described procedure in the case where the redirect server is used. Therefore, detailed description will be omitted (see steps A6 to A14).

When the transmission of image data is finished and the facsimile communication is completed, then the source facsimile device 2a sends a predetermined communication to the source SIP adapter 1a (step 816).

Upon receipt of this communication, the source SIP adapter 1a sends a BYE message to the SIP server 3 (step B17).

Upon receipt of the message in the step B17, the SIP server 3 similarly forwards the BYE message to the destination SIP adapter 1b (step 18).

Upon receipt of the BYE message, the destination SIP adapter 1b sends a predetermined notification to the destination facsimile device 2b (step B19).

Upon receipt of the notification in the step B19, the destination facsimile device 2b here terminates the facsimile reception and brings itself back to an original standby state (step B20).

Thereafter, a teardown of the session is completed through transmission of an OK response from the destination SIP adapter 1b and then from the SIP server 3 (steps B21 and B22).

### 1.5) Operation

### EXAMPLE III

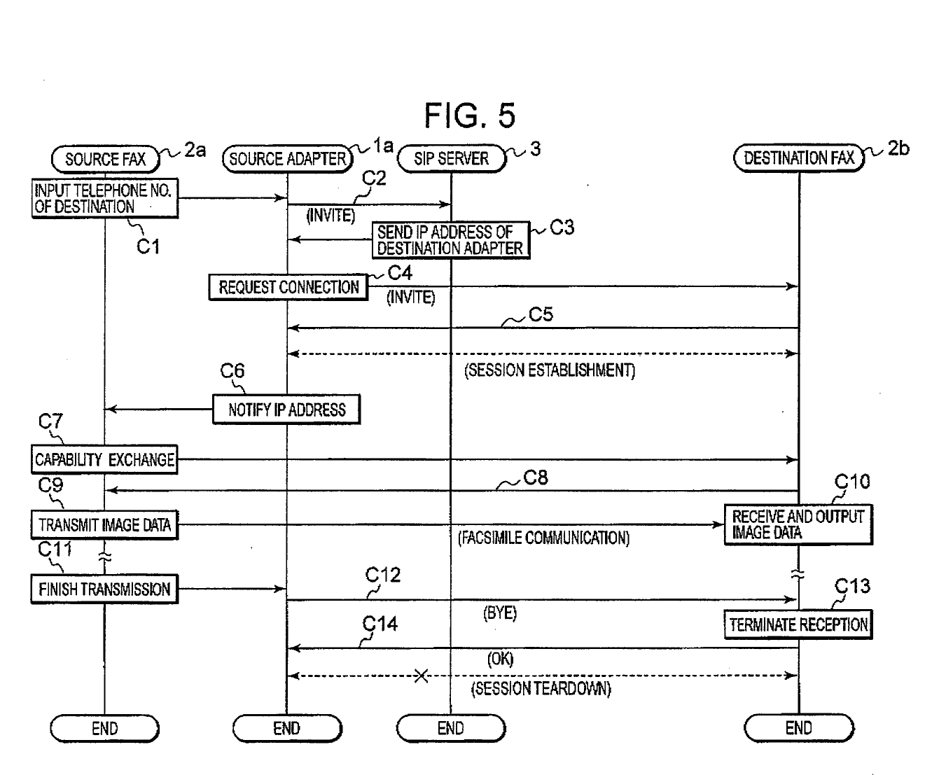

Next, description will be given of an operation procedure in the case where the destination facsimile device is provided with a SIP function, in the coordinative operations of the SIP adapter, facsimile devices and SIP server according to the present embodiment, with reference to FIG. 5.

FIG. 5 is a sequence diagram showing operation processes in the coordinative operations of the SIP adapter, facsimile devices and SIP server according to the first embodiment of the present invention, in the case where the destination facsimile device is provided with a SIP function.

Note that in the operation in this example, the call control using the redirect server is performed, and the destination facsimile device 2b has a SIP function and is not connected to the destination SIP adapter 1b.

First, the telephone number of the destination facsimile device 2b is input to the source facsimile device 2a and sent to the source SIP adapter 1a (step C1).

Upon receipt of the telephone number, the source SIP adapter 1a sends an INVITE request containing this telephone number to the SIP server 3 (step C2).

Next, upon receipt of the INVITE request, the SIP server 3 refers to the telephone number contained in the request, extracts a corresponding IP address, and sends the IP address back to the source SIP adapter 1a (step C3). Note that the IP address extracted here is the IP address of the destination facsimile device 2b. Therefore, in such a case where a SXP adapter 1 is not provided, an IP address to be registered in advance is the IP address of a facsimile device 2 as a SIP terminal.

Upon receipt of the IP address of the destination facsimile device 2b, the source SIP adapter 1a sends an INVITE request to that IP address, that is, the destination facsimile device 2b, thereby requesting a participation in a session (connection) (step C4).

When the destination facsimile device 2b responds to the request in the step C4 with an OK response and the source SIP adapter 1a receives this response (step C5), a session with the destination facsimile device 2b is established.

The source SIP adapter 1a, which has received the IP address of the destination facsimile device 2b in the step C3, here sends this IP address to the source facsimile device 2a (step C6).

The source facsimile device 2a carries out capability exchange (steps C7 and C8) and then carries out facsimile transmission (steps C9 and C10).

Note that the steps C7 to C10 are similar to the above-described steps A11 to A14, and therefore detailed description shall be referred to steps A11 to A14.

When the transmission of image data is finished and the facsimile communication is completed, then the source facsimile device 2a sends a predetermined notification to the source SIP adapter 1a (step C11).

Upon receipt of this notification, the source SIP adapter 1a sends a BYE message to the destination facsimile device 2b (step C12).

Upon receipt of the BYE message, the destination facsimile device 2b terminates the facsimile reception (step C13). At the same time, in response to the BYE message, the destination facsimile device 2b sends an OK response back to the source SIP adapter 1a (step C14), whereby a teardown of the session is completed.

### 1.6) Advantages

As described above, since the SIP adapter 1 having the SIP function operates in concert with the SIP server 3, the SIP adapter 1 can establish a session between devices, based on the direct server function or proxy server function of SIP, allowing the facsimile devices to directly communicate with each other.

Accordingly, since communication can be carried out without being routed through a device such as a server in the course of the communication, high-quality facsimile data can be transmitted and received at high speed.

In addition, connecting this SIP adapter 1 to the facsimile device 2 enables this facsimile device 2 to carry out facsimile communication over a SIP network.

Therefore, regardless of whether or not a facsimile device has a SIP function and/or whether or not there is a difference on the protocol, the SIP adapter 1 can be connected to a conventional facsimile device and therefore can be widely used. Accordingly, the use of a SIP-compliant facsimile device becomes possible easily at low cost.

In addition, telephone numbers and corresponding IP addresses are mapped and stored in advance, based on the registrar server function of SIP. Therefore, when a caller merely enters an arbitrary telephone number and places a call, the telephone number is automatically translated into an IP address, and direct communication with the corresponding facsimile device 2 over an IP network can be carried out.

Accordingly, when a connection is made, an input of an identification code other than a telephone number is unnecessary, eliminating the need to store or manage such identification codes. Therefore, it is possible to provide a facsimile service excellent in operability and convenience.

As described above, according to the SIP facsimile communication method of the present embodiment, a SIP facsimile service excellent in operability, convenience and versatility can be easily realized and provided at low cost.

### 2. Second Embodiment

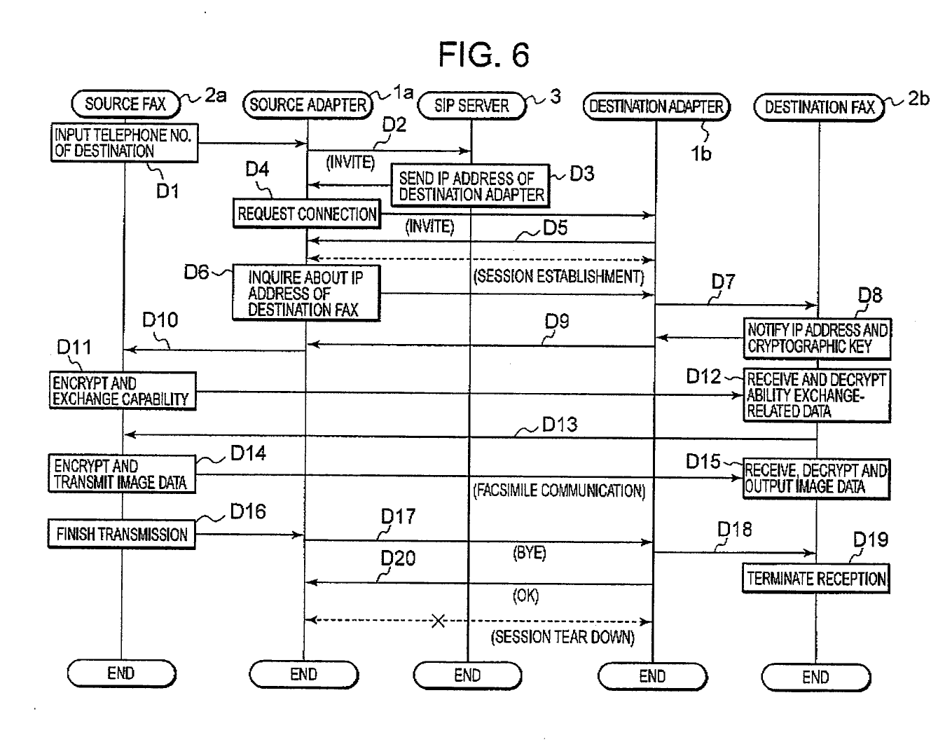

Next, encryption processing used in a SIP facsimile communication method according to a second embodiment of the present invention will be described with reference to FIG. 6.

FIG. 6 is a sequence diagram showing operation processes in the case where encryption and decryption are carried out by using SSL (Secure Socket Layer)/TLS (Transport Layer Security) in the SIP facsimile communication method according to the second embodiment of the present invention.

Incidentally, SSL and TLS are protocols for encrypting information for transmission and reception and are technologies that can prevent data falsification, eavesdropping and spoofing by combinational use of security techniques such as public key cryptography, secret key cryptography, digital certificate, and hush function.

In the present embodiment, steps D1 to D7 are similar to the above-described steps A1 to A7, and therefore detailed description will be omitted.

In step D8, the destination facsimile device 2b passes on a predetermined cryptographic key along with its own IP address, which are received by the destination SIP adapter 1b.

Next, these IP address and cryptographic key are passed on to the source facsimile device 2a via the source SIP adapter 1a (steps D9 and D10).

Thereafter, data related to capability exchange is subjected to predetermined encryption processing using the above cryptographic key and then sent out (step D11). The destination facsimile device 2b decrypts the encrypted data received and thereby obtains capability data (step D12).

Thereafter, the destination facsimile device 2b sends related capability data to the source facsimile device 2a (step D13). Note that although only the data sent from the source facsimile device 2a to the destination facsimile device 2b is encrypted in FIG. 6, the data sent in the reverse direction may also be subjected to encryption processing using the cryptographic key similarly, so that the security can be further increased.

When the capability exchange is finished, the source facsimile device 2a subjects scanned image data to encryption processing using the cryptographic key and transmits the encrypted image data (step D14). The destination facsimile device 2b decrypts the encrypted image data received and then outputs the data (step D15).

A procedure of steps D16 to D20 is similar to the above-described steps A15 to A19, and therefore detailed description will be omitted.

As described above, the SIP facsimile communication method according to the present embodiment not only demonstrates effects similar to those of the first embodiment but also can include the process of passing on a cryptographic key for encryption communication using SSL/TLS. Therefore, it is possible to effectively prevent eavesdropping, falsification, proofing, and the like in the course of transmission and reception of facsimile data.

Hereinabove, the SIP adapters and SIP facsimile communication methods of the present invention have been described by showing preferred embodiments. However, a SIP adapter and SIP facsimile communication method according to the present invention are not limited to the above-described embodiments. It is needless to say that various changes and modifications can be made without departing from the scope of the present invention.

For example, the SIP adapter of the present invention may be provided not only for a facsimile device but also for a network-capable device such as an IP telephone or a personal computer. In addition, the type of a communication medium is not limited either.

Further, a security measure is not limited to the use of encryption. By installation of a firewall or the like that controls the open/close of a port on an application, it is possible to prevent a third party's malicious access and to further increase the security.

The present invention can be favorably used with a facsimile device having no SIP function or a facsimile device that has a SIP function but operates based on a partially different protocol.

1. An adapter for providing a network-capable device with SIP (Session Initiation Protocol) function to allow SIP communication of the network-capable device through an IP (Internet Protocol) network on which a SIP server is present, comprising:
a receiving section for receiving a destination telephone number of a destination network-capable device from the network-capable device;
a session establishment section for establishing a session between the adapter and a destination SIP terminal by using the SIP server, wherein the destination SIP terminal is provided to the destination network-capable device, wherein the session establishment section sends the destination telephone number to the SIP server, which uses a redirect server function to obtain the first IP address of the destination SIP terminal;
an IP address acquisition section for acquiring a second IP address of the destination network-capable device from the destination SIP terminal through the session; and
an IP address transfer section for transferring the second IP address to the network-capable device, allowing direct communication between the network-capable device and the destination network-capable device over the IP network.

2. The adapter according to claim 1, wherein the session establishment section includes a first address acquisition section for sending the destination telephone number to the SIP server and receiving the first IP address from the SIP server, wherein the session establishment section sends a connection request to the destination SIP terminal to establish the session.

3. The adapter according to claim 1, wherein the SIP server uses a proxy server function to send a connection request to the destination SIP terminal based on the first IP address to cause the adapter and the destination SIP terminal to establish the session.

4. The adapter according to claim 1, wherein the destination SIP terminal is incorporated as a SIP function in the destination network-capable device.

5. The adapter according to claim 1, wherein the session establishment section also establishes a session with a source SIP terminal when receiving a connection request from either the source SIP terminal or the SIP server, wherein the IP address acquisition section also acquires the first IP address of the network-capable device and sends the first IP address to the source SIP terminal through the session with the source SIP terminal.

6. The adapter according to claim 1, wherein the first IP address of the destination SIP terminal and the destination telephone number of the destination network-capable device are previously registered in a database by a registrar server function of the SIP server.

7. The adapter according to claim 5, wherein an IP address of the adapter and a telephone number of the network-capable device are previously registered in a database by a registrar server function of the SIP server.

8. The adapter according to claim 1, wherein the SIP function is defined in RFC (Request for Comments) 3261.

9. The adapter according to claim 1, wherein the network-capable device is a facsimile device.

10. The adapter according to claim 1, wherein the network-capable device is an IP telephone device.

11. A method for providing SIP (Session Initiation Protocol) communication between a first network-capable device provided with a first SIP terminal and a second network-capable device provided with a second SIP terminal through an IP (Internet Protocol) network on which a SIP server is present, comprising:
at the first SIP terminal,
receiving a destination telephone number of a destination network-capable device from the first network-capable device;
sending the destination telephone number to the SIP server, wherein the SIP server uses a redirect server function to obtain a first IP address of the second SIP terminal;
at the first and second SIP terminals,
establishing a session between the first SIP terminal and the second SIP terminal by using the SIP server;
acquiring a second IP address of the second network-capable device from the second SIP terminal through the session to transfer the second IP address to the first network-capable device; and
at the first and second network-capable devices,
performing direct communication between the first network-capable device and the second network-capable device over the IP network.

12. The method according to claim 11, further comprising:
at the second SIP terminal,
receiving a connection request from either the first SIP terminal or the SIP server;
establishing the session with the first SIP terminal;
acquiring the second IP address of the second network-capable device from the second SIP terminal; and
sending the second IP address to the first SIP terminal through the session.

13. A program for instructing a computer to function as an adapter for providing a network-capable device with SIP (Session Initiation Protocol) function to allow SIP communication of the network-capable device through an IP (Internet Protocol) network on which a SIP server is present, the adapter comprising:
a receiving section for receiving a destination telephone number of a destination network-capable device from the network-capable device;
a session establishment section for establishing a session between the adapter and a destination SIP terminal by using the SIP server, wherein the destination SIP terminal is provided to the destination network-capable device, wherein the session establishment section sends the destination telephone number to the SIP server, which uses a redirect server function to obtain the first IP address of the destination SIP terminal;
an IP address acquisition section for acquiring a second IP address of the destination network-capable device from the destination SIP terminal through the session; and
an IP address transfer section for transferring the second IP address to the network-capable device, allowing direct communication between the network-capable device and the destination network-capable device over the IP network.

14. The program according to claim 13, wherein the session establishment section also establishes a session with a source SIP terminal when receiving a connection request from either the source SIP terminal or the SIP server, wherein the IP address acquisition section also acquires the first IP address of the network-capable device and sends the first IP address to the source SIP terminal through the session with the source SIP terminal.

15. An adapter for providing a network-capable device with SIP (Session Initiation Protocol) function to allow SIP communication of the network-capable device through an IP (Internet Protocol) network on which a SIP server is present, comprising:
a first controller controlling communication with the network-capable device such that a destination telephone number is received from the network-capable device and a destination IP address corresponding to the destination telephone number is sent back to the network-capable device; and
a second controller controlling SIP communication such that the destination IP address is acquired from a destination network-capable device by using the SIP server, allowing direct communication with the destination network-capable device through the IP network.

16. A facsimile system connectable to an IP (Internet Protocol) network, comprising:
a facsimile device; and
an adapter connected to the facsimile device, for providing the facsimile device with SIP (Session Initiation Protocol) function to allow SIP communication of the facsimile device through the IP network on which a SIP server is present,
wherein the adapter comprises:
a first controller controlling communication with the network-capable device such that a destination telephone number is received from the network-capable device and a destination IP address corresponding to the destination telephone number is sent back to the network-capable device; and
a second controller controlling SIP communication such that the destination IP address is acquired from a destination network-capable device by using the SIP server, allowing direct communication with the destination network-capable device through the IP network.
